(19) United States
(12) Patent Application Publication
(10) Pub. No.: US 2014/0032312 A1
(43) Pub. Date: Jan. 30, 2014

(54) SYSTEMS, METHODS, AND COMPUTER PROGRAM PRODUCTS FOR PROVIDING OFFERS TO MOBILE WALLETS

(71) Applicant: JVL Ventures, LLC, New York, NY (US)

(72) Inventors: Kai P. Johnson, San Diego, CA (US); Joseph Morris, Monsey, NY (US); Vatatmaja, Overland Park, KS (US)

(73) Assignee: JVL Ventures, LLC, New York, NY (US)

(21) Appl. No.: 13/948,854

(22) Filed: Jul. 23, 2013

Related U.S. Application Data
(60) Provisional application No. 61/675,450, filed on Jul. 25, 2012.

(51) Int. Cl. G06Q 30/02

(52) U.S. Cl. CPC G06Q 30/0248
USPC 705/14.47

(57) ABSTRACT

Systems, methods, and computer program products are provided for providing offers to mobile wallets. A request including offer data and authentication data is received from a client portal system. The authentication data is validated. A validation result based on the validation of the authentication data is generated. A response including the validation result is transmitted to the client portal system. An offer including the offer data is transmitted to a mobile device. The offer data includes an offer identifier (ID), and the mobile device includes a mobile wallet associated with the authentication data.

### CROSS REFERENCE TO RELATED APPLICATION

This application claims priority to U.S. Provisional Application No. 61/675,450, filed Jul. 25, 2012, the contents of which are incorporated herein by reference.

### BACKGROUND

1. Field

Example aspects described herein relate to merchant offers for use with mobile wallets, and more particularly to systems, methods, and computer program products for providing offers to mobile wallets.

2. Related Art

Mobile commerce transactions refer to the ability to perform commerce transactions electronically using wireless technology such as mobile devices. One example of a mobile commerce transaction is a purchase of goods in exchange for payment, all of which is performed digitally without the need to visit a brick and mortar business. In addition to the ability to purchase goods electronically, other examples of mobile commerce transactions include money transferring; distribution and use of vouchers, coupons and loyalty cards; mobile marketing and advertising; and the like.

Mobile commerce transactions can be performed using mobile wallets provisioned on a mobile device. A mobile wallet on a mobile device stores payment account information (i.e., credentials associated with a financial instrument such as a credit card or debit card). The mobile device equipped with the mobile wallet can be used at a point-of-sale (PoS) system to perform a transaction by, for example, waving, tapping or scanning the mobile device.

Merchant offers are coupons, discounts, promotions and the like, issued by a business, retailer or seller for use in a mobile commerce transaction. A merchant offer can be used during the mobile commerce transaction, for example, to offset the total payment due (i.e., discount) or to receive additional goods (i.e., promotion).

In particular, during a mobile commerce transaction a purchaser can apply an offer such as a discount to the transaction, for example, by inputting an offer code. Alternatively, a merchant can publish offers that can in turn be accessed and used by customers during a mobile commerce transaction.

One technical challenge associated with creating, acquiring and using offers in mobile commerce transactions involves the ability to provide offers that can be centrally collected on a mobile wallet in a mobile device and, in turn, be used without the need to communicate with the merchant or merchant system issuing the offer. Yet another technical challenge involves providing merchants with offers configured to be “clipped” to a mobile wallet.

### BRIEF DESCRIPTION

The example embodiments presented herein meet the above-identified needs by providing systems, methods, and computer program products for providing offers to mobile wallets.

In one embodiment, a system for managing offers in a mobile commerce environment includes at least one memory and a processor coupled to the at least one memory. A request including offer data and authentication data is received from a client portal system. The authentication data is validated. A validation result based on the validation of the authentication data is transmitted to the client portal system. An offer including the offer data is transmitted to a mobile device. The offer data includes an offer identifier, and the mobile device includes a mobile wallet associated with the authentication data.

In another embodiment, a method for managing offers in a mobile commerce environment includes receiving a request from a client portal system, the request including offer data and authentication data; validating the authentication data; generating a validation result based on validating the authentication data; transmitting, to the client portal system, a response including the validation result; and transmitting an offer including the offer data to a mobile device. The offer data includes an offer identifier (ID), and the mobile device includes a mobile wallet associated with the authentication data.

In another embodiment, a non-transitory computer readable-medium has stored thereon sequences of instructions for causing one or more processors to: receive a request from a client portal system, the request including offer data and authentication data; validate the authentication data; generate a validation result based on validating the authentication data; transmit, to the client portal system, a response including the validation result; and transmit an offer including the offer data to a mobile device. The offer data includes an offer identifier (ID), and the mobile device includes a mobile wallet associated with the authentication data.

### BRIEF DESCRIPTION OF THE DRAWINGS

The features and advantages of the example embodiments of the invention presented herein will become more apparent from the detailed description set forth below when taken in conjunction with the following drawings.

FIG. 1 is a diagram of a system for providing offers into mobile wallets according to an exemplary embodiment.

FIG. 2 is a diagram illustrating a process for creating an offer according to an exemplary embodiment.

FIG. 3 is a diagram illustrating a process for acquiring an offer according to an exemplary embodiment.

FIG. 4 is a collaboration diagram of functional modules deployed on a computer system in accordance with an example embodiment of the present invention.

### DETAILED DESCRIPTION

### I. Overview

The example embodiments presented herein are directed to systems, methods, and computer program products for clipping offers into mobile wallets, which are described herein in terms of a merchant offer. This description is not intended to limit the application of the example embodiments presented herein. In fact, after reading the following description, it will be apparent to one skilled in the relevant art(s) how to implement the following example embodiments in alternative embodiments involving an entity (e.g., box office, mass transit terminal) making a promotion (e.g., discount, admission) available for acquisition by and into mobile devices of one or more other entities (e.g., clients, customers).

The terms “clip,” “acquire,” “obtain,” “provide,” and/or any form (e.g., plural, active, etc.) of these terms are used interchangeably to refer to the process, functions and/or instructions, which when performed and/or executed result in the communication of an offer (or offers and the like) from one system (e.g., MoCom platform, merchant system) to a digital device (e.g., mobile device). Generally, an offer existing on a MoCom platform is acquired from a client portal to a mobile wallet. One or more offers are created by a merchant system. Each offer conforms to a predetermined format, so that each offer may be compatible and usable by mobile wallets. The merchant system transmits offers, including offer data (e.g., merchant ID, offer name, creation date, expiration date, offer content, etc.) to the MoCom platform. In turn the MoCom platform reviews the offer and offer data and approves and/or certifies the offer. Once certified the MoCom platform stores offer data for the offer and assigns it a unique identifier. The MoCom platform then creates and adds a script to the offer, so that it may be used in mobile wallets, and transmits the offer to the corresponding merchant system where it can be made available for acquisition.

The offer can be acquired from the client portal by performing a “clip.” The client portal is prompted for credentials, which the MoCom platform validates to ensure that the corresponding mobile wallet is valid and/or authentic. A result of the validation is transmitted from the MoCom platform to the client portal, and, if valid, the MoCom platform transmits the offer to the mobile wallet.

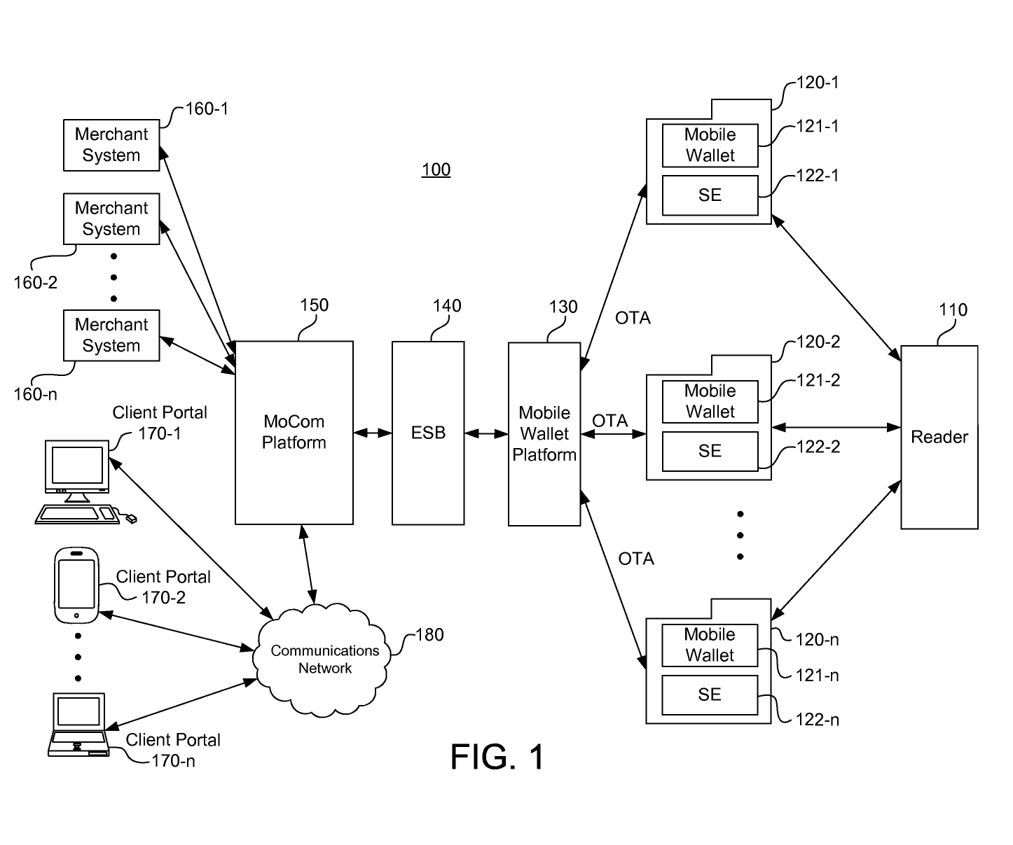

The features discussed above are described in further detail below, with reference to FIGS. 1 to 4.

### II. System

FIG. 1 is a diagram of system 100 for providing offers to mobile wallets according to an exemplary embodiment. As shown in FIG. 1, system 100 includes a mobile commerce (MoCom) platform 150, enterprise service bus (140), mobile wallet platform 130, mobile devices 120-1, 120-2, . . . , 120-n (collectively “120”), a proximity or near field communication (NFC) contactless reader 110, merchant systems 160-1, 160-2, . . . , 160-n (collectively “160”) and client portals 170-1, 170-2, . . . , 170-n.

Each mobile device 120 may be, for example, a cellular phone, tablet or the like, and includes a respective mobile wallet (i.e., mobile wallet 121-1, 121-2, . . . , 121-n (collectively “121)) and secure element (i.e., SE 122-1, 122-2, . . . , 122-n (collectively “122”)).

In addition, although not illustrated in FIG. 1, each mobile device 120 includes a processor, memory, a contactless frontend (CLF), a baseband modem, and a user interface such as a display. A baseband modem is a digital modem that is used for mobile network communications. A CLF is circuitry which handles the analog aspect of contactless or NFC communications and the communication protocol layers of a contactless transmission link. A CLF also is used to exchange data between reader 110 and the secure elements 122 contained in each mobile device 120, for example, during the execution of a mobile commerce transaction.

Each of the secure elements 122 may be implemented as a Universal Integrated Circuit Card (UICC), embedded SE card, secure micro secure digital (microSD) card, and the like. Each secure element 122 is generally considered secure because it is a self-contained system, including dedicated memory, and is protected by hardware and software hardening techniques that are verified by independent testing. Each secure element 122 includes (i.e., has stored thereon) a commerce applet, capable of operating as a storage container and interface for offer data management, and may be used to redeem an offer during a contactless transaction, for example, at the reader 110. Offer data can also, and/or alternatively, be stored on the memory of a mobile device 120. Each secure element 122 communicates (e.g., via the CLF) offer data to reader 110 using ISO 7816 commands over the NFC ISO 14443 protocol.

Mobile device 120 further includes a corresponding mobile wallet 122 (i.e., mobile wallet application) having instructions which, when executed by the processor of a mobile device, cause the mobile device to act as an instrument, for example, for processing transactions such as mobile commerce transactions (e.g., contactless commerce and/or payment transactions).

Moreover, each mobile device 120 is communicatively coupled to the reader 110 and to a mobile wallet platform 130. The mobile wallet platform may include one or more servers for storing offer data, and is configured to manage (i.e., transmit, receive, request, process) offers and related data. The reader 110 may include a point of sale (POS) terminal within the same housing or, alternatively, may be housed separately. The reader 110 may be communicatively coupled to each of the merchant systems 160, for processing contactless transactions.

U.S. patent applications Ser. Nos. 13/901,134 and 13/901,188, entitled “Systems, Methods, and Computer Program Products for Providing a Contactless Protocol,” which are incorporated herein by reference in their entirety, describe protocols for performing contactless transactions such as payments and commerce transactions using a mobile device, secure element, mobile wallet and/or contactless reader.

It should be understood that other communications between the aforementioned devices may include communications with or through other intervening systems, hardware, and/or software, and such communications may include receiving, transferring, and/or managing data.

Mobile devices 120 are communicatively coupled to a mobile wallet platform 130, which in turn is communicatively coupled to a mobile commerce (MoCom) platform 150 via an ESB 140. U.S. patent application Ser. No. 13/848,962, entitled “Systems, Methods, and Computer Program Products for Provisioning Payment Accounts into Mobile Wallets and Managing Events,” which is incorporated herein by reference in its entirety, describes communications with mobile wallets using an ESB.

The MoCom platform 150 may include one or more servers for: storing and managing data related to mobile commerce transactions (e.g., offer data, loyalty data, rewards data) and/or merchant data (i.e., information related to merchant systems 160), and; rules and/or means for processing redeemed offers, distributing offers to mobile wallets, and the like. Additionally, the MoCom platform 150 is communicatively coupled to one or more client portals 170, for example over a communications network such as the internet. Client portals 170 may be any system such as a personal computer (e.g., 170-1), mobile device (e.g., 170-2), laptop (e.g., 170-n), tablet, workstation or the like capable of accessing the MoCom platform 150, for example, for clipping and/or redeeming offers.

The MoCom platform is further communicatively coupled to one or more merchant systems 160. A merchant system is a system managed by a merchant (e.g., business, retailer) for example, for managing mobile commerce transactions and for creating and processing merchant offers.

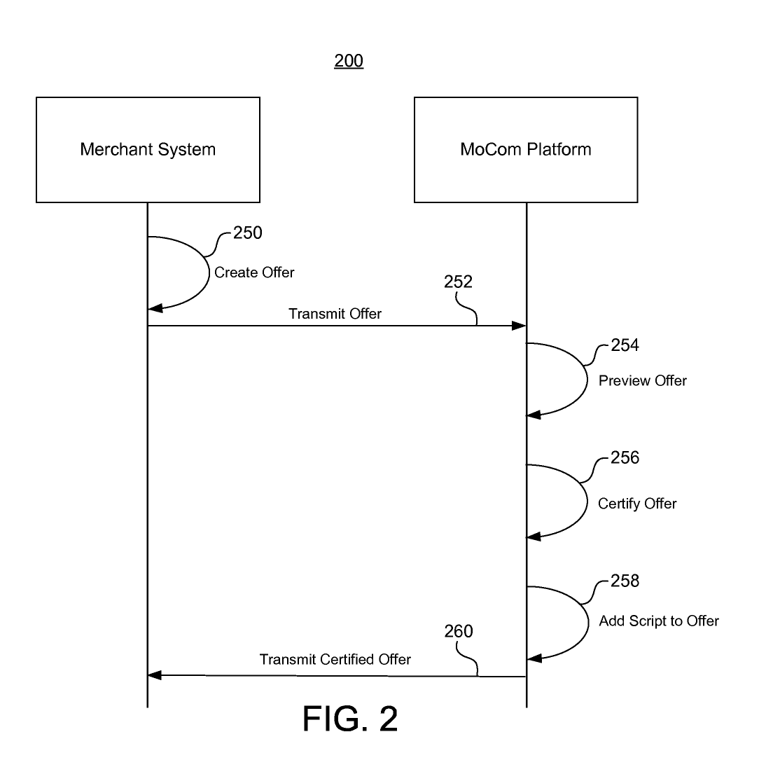

In one exemplary embodiment, a merchant system (e.g., merchant system 160-1) transmits an offer to a MoCom platform (e.g., MoCom platform 150) to be certified and configured to be “clipped” (i.e., acquired) into a mobile wallet (e.g., mobile wallet 121-1). This exemplary embodiment is described in further detail below, for example, with reference to FIG. 2.

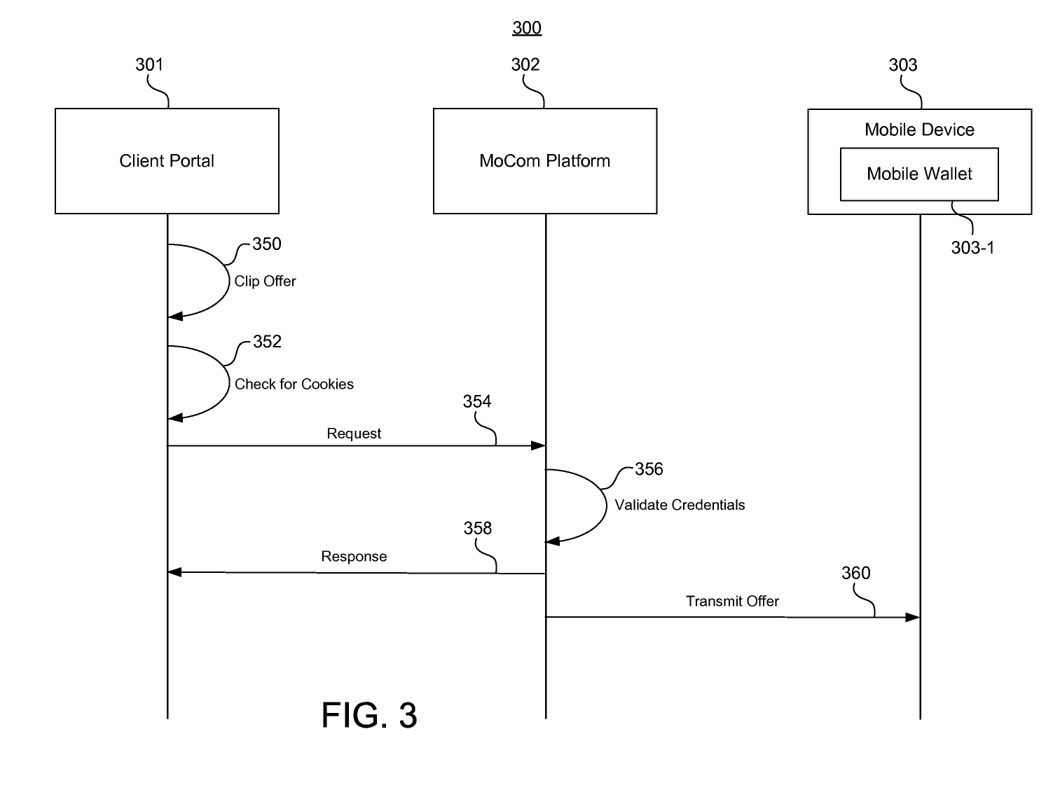

In another exemplary embodiment, a client portal (e.g., client portal 170-1) is used to clip an offer, existing on a MoCom platform (e.g., MoCom platform 150) into a mobile wallet (e.g., mobile wallet 121-1). This exemplary embodiment is described in further detail below, for example, with reference to FIG. 3.

### III. Process

### A. Creating an Offer

FIG. 2 is a diagram illustrating a process 200 for creating an offer according to an exemplary embodiment. At step 250, a merchant system 201 (e.g., FIG. 1, merchant system 160-1) creates one or more offers (i.e., a batch of offers) by creating and/or retrieving offer data. The merchant system 201 conforms each offer according to a predetermined format, in order for each offer to be compatible and usable by a mobile wallet (e.g., FIG. 1, mobile wallet 121-1). For example, the merchant system 201 ensures that each offer includes certain types of offer data to be approved for use by the mobile wallet.

At step 252, the merchant system 201 transmits an offer to a MoCom platform 202 (e.g., FIG. 1, MoCom platform 150). It should be understood that a merchant system can transmit one offer or a batch of multiple offers to a MoCom platform. The offer transmitted at step 252 includes corresponding offer data such as a merchant ID, offer name, creation date, expiration date, maximum number of clips and offer content.

A merchant ID is a unique identifier corresponding to a merchant or merchant system by which the offer was created. The merchant ID also indicates the merchant system eligible or capable to accept and apply the offer when used (i.e., redeemed) in a contactless transaction. An offer name is a unique caption or label assigned to the offer, by which the offer can be identified. A creation date is the date on which the offer is created by a merchant or merchant system, and may be used to calculate when the offer becomes eligible to be used. An expiration date is the last date on which the offer may be used. The maximum number of clips indicates the number of times the offer can be clipped (i.e., acquired and added to a mobile wallet). That is, if the number of times the offer is clipped reaches the maximum number of clips allowed for the offer, clipping of that offer may be disabled. Offer content includes information indicating the terms of the offer (e.g., 20% off), images to be used for the offer, links, text and the like. In particular, the offer content may include an offer title, offer description, offer expiration, offer image, offer redeemable version, associated barcode and any terms, conditions and the like related to the offer.

At step 254, the MoCom platform 202 reviews the received offer. In particular, the MoCom platform 202 reviews the offer data included in the offer to ensure that it is complete, based on a predetermined set of requirements, and that it meets certain predetermined certification criteria. For example, a predetermined criterion may be that offer data of the offer not include inappropriate (e.g., obscene, vulgar) content. Accordingly, the offer may be analyzed to ensure that it includes appropriate content. If the MoCom platform 202 determines that the offer data of the offer is complete and meets the predetermined criteria, the offer is deemed to be approved. Alternatively, if the MoCom platform 202 determines that the offer data of the offer is incomplete and/or does not meet the predetermined criteria, the offer is deemed to be rejected.

If during the review at step 254, the offer is approved, the MoCom platform certifies the offer as an offer that can be added to and used with a mobile wallet, at step 256. The MoCom platform 202 also stores offer data (and any other data received from the merchant system 201) of each offer upon being certified. In an alternative embodiment, the MoCom platform assigns an offer code corresponding to each offer. An offer code is a unique identifier associated with a certified offer. The MoCom platform 202 may also store received (i.e., from a merchant system) and/or generated data associated with an offer, as shown in Tables 1-7 of Appendix A.

In turn, at step 258, the MoCom platform 202 creates and adds a script to the certified offer. The script includes instructions, for example, to: determine whether valid cookies exist in a web browser; request credentials from the user, validate the MoCom platform; transmit an offer; and/or transmit error and help message indications to display via, for example, a web browser. The script includes techniques or mechanisms (e.g., Asynchronous JavaScript and XML (Ajax)) used to authenticate the mobile wallet to which the offer is to be added as a valid and existing mobile wallet. That is, the script is embedded to an offer in order for the authentication process to occur when an offer is clipped.

The process of authenticating a mobile wallet and clipping an offer is described in further detail below, with reference to FIG. 3.

At step 260, the MoCom platform 202 transmits the certified offer, including the script added at step 258, to the merchant system 201. The merchant system (or merchant) can then make the certified offer available to consumers (i.e., mobile devices equipped with mobile wallets) by displaying and/or publishing the offer. For example, the offer can be made available via a mobile application, website, advertisement, or may be distributed via e-mail, text message, or any method of transmitting a uniform resource locator (URL) and the like. Once the offer is made available, the offer can be acquired (e.g., clipped, scanned, tapped) and added to a mobile wallet for use in a mobile commerce transaction, as described in further detail below, with reference to FIG. 3.

### B. Acquiring an Offer

Once an offer is certified and transmitted to a merchant system (as shown in steps 258 and 260 of FIG. 2), that merchant system can make the offer available for acquisition by publishing or displaying a link, icon, text, image, barcode, quick response (QR) code, etc. associated with the offer on a webpage, application, advertisement and the like. In turn, the published or displayed offer can be acquired, starting with clipping (e.g., selecting, scanning, tapping) the offer from any client portal or device capable of accessing a MoCom platform (e.g., FIG. 1, MoCom platform 150). Such access to the MoCom platform may be achieved for example, via the internet.

In particular, clipping an offer can be achieved by clicking (or any other method of selecting) the published or displayed offer (e.g., link, icon, etc.). An offer can also be clipped by scanning the offer using a mobile device equipped with a camera to scan a barcode or QR code associated with the offer.

Alternatively, an offer can be clipped by performing a “tap,” which is achieved by placing a mobile device within a predetermined proximity of a reader at a POS (e.g., FIG. 1, reader 110). The reader, in turn, loads a webpage or the like on the mobile device. That webpage displays available offers which can be

acquired by clicking and/or selecting the offer on the mobile device used to perform the tap, for example, via a user interface of the mobile device. U.S. patent applications Ser. Nos. 13/901,134 and 13/901,188, entitled “Systems, Methods, and Computer Program Products for Providing a Contactless Protocol,” which are incorporated herein by reference in their entirety, describe performing a “tap” (i.e., “tapping”) to conduct a contactless transaction.

FIG. 3 is a diagram illustrating a process 300 for acquiring an offer according to an exemplary embodiment. In the exemplary embodiment illustrated in FIG. 3, a personal computer is used to clip a discount offer into a mobile wallet by clicking a link corresponding to the offer. It should be understood any type of client portal may be used to clip any type of offer in accordance with any method, as described herein

At step 350, a user on a personal computer connected to the internet (i.e., client portal 301) clips an offer (i.e., a discount) by clicking on an icon published on a merchant website. The icon is associated with an offer, as described above with reference to FIG. 2.

When the offer is clipped at step 350, the script embedded to the offer (e.g., the script added at step 258 of FIG. 2) is invoked and executes instructions to determine whether “cookies” are present in the client portal 301, at step 352. Cookies are data collected in a system or device (e.g., client portal 301) indicating the history and/or state of a webpage with regard to the mobile device. For example, cookies can be used to indicate whether a webpage has previously been visited on the system or device and/or to store login credentials previously used to log into a webpage.

If it is determined, at step 352, that cookies for the webpage where the offer is clipped are not present in the client portal 301, the client portal 301 prompts for either: (1) credentials (e.g., user ID and password), or (2) an option to register. That is, the user of the client portal 301 can either input credentials or choose to register in order to obtain credentials, in the event that registration has not previously been performed. If the user of the client portal 301 chooses to register, the webpage on the client portal 301 is redirected to a registration webpage. In an alternative embodiment, the user of the client portal 301 can elect to not store cookies on the client portal 301 upon inputting the credentials. Once credentials are input (or once registration has been achieved and credentials have been obtained), a clip request including the credentials is transferred to a MoCom platform 302 (e.g., FIG. 1, MoCom platform 150).

Alternatively, if it is determined at step 352 that cookies for the webpage where the offer is clipped are present in the client portal 301, a clip request including at least a portion of the data in the cookies (e.g., credentials) is transferred to the MoCom platform 302, at step 354.

In particular, the clip request including request data is transferred to the MoCom platform 302, at step 354. The request data includes a merchant ID, a merchant name, a user ID, a password and an offer code. The merchant ID and merchant name are unique identifiers corresponding to a merchant and/or merchant system associated with the offer. The user ID and password are a unique combination of login credentials (e.g., alphanumeric) associated with a user of a mobile wallet. The user ID and password (i.e., authentication data) are used to authenticate a mobile wallet. An offer code is a unique identifier associated with a certified offer.

At step 356, the MoCom platform 302 authenticates (i.e. validates) the user ID and password received from the client portal 301. That is, the MoCom platform 302 checks whether the user ID and password: (1) have previously been associated with a mobile wallet (i.e., a mobile wallet has previously been registered and assigned those credentials), and (2) are a matching pair. If the user ID and password are authenticated by the MoCom platform 302, the offer is subsquently stored in a mobile wallet associated with that user ID and password.

The MoCom platform 302, at step 358, transmits a response to the client portal 301 indicating the result of the authentication performed in step 356. The response includes a response code and corresponding message indicating, for example, whether the authentication of the user ID and password succeeded or failed.

If the authentication performed at step 356 is successful, the MoCom platform 302 transmits the offer (i.e., at least a portion of the data associated with the offer) to a mobile device 303, on which the mobile wallet 303-1 (i.e., FIG. 1, mobile wallet 303-1) associated with the authenticated user ID and password is stored. The mobile device 303, in turn, stores the received offer (and corresponding data) in the mobile wallet and makes the offer available for use in a mobile commerce transaction.

### IV. Computer Readable Medium Implementation

The example embodiments described above such as, for example, the systems and procedures depicted in or discussed in connection with FIGS. 1-3 or any part or function thereof, may be implemented by using hardware, software or a combination of the two. The implementation may be in one or more computers or other processing systems. While manipulations performed by these example embodiments may have been referred to in terms commonly associated with mental operations performed by a human operator, no human operator is needed to perform any of the operations described herein. In other words, the operations may be completely implemented with machine operations. Useful machines for performing the operation of the example embodiments presented herein include general purpose digital computers or similar devices.

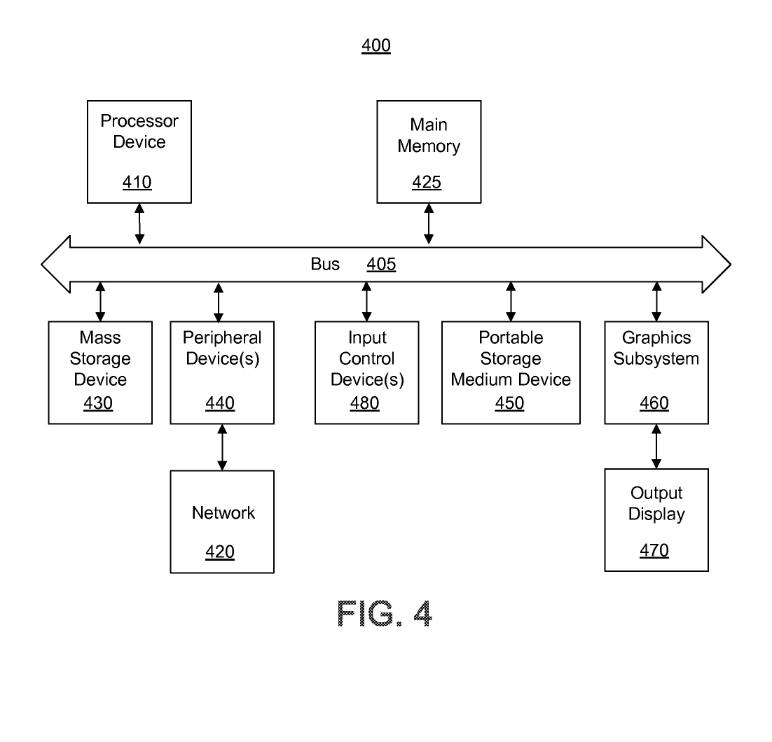

FIG. 4 is a block diagram of a general and/or special purpose computer 400, in accordance with some of the example embodiments of the invention. The computer 400 may be, for example, a user device, a user computer, a client computer and/or a server computer, among other things.

The computer 400 may include without limitation a processor device 410, a main memory 425, and an interconnect bus 405. The processor device 410 may include without limitation a single microprocessor, or may include a plurality of microprocessors for configuring the computer 400 as a multi-processor system. The main memory 425 stores, among other things, instructions and/or data for execution by the processor device 410. The main memory 425 may include banks of dynamic random access memory (DRAM), as well as cache memory.

The computer 400 may further include a mass storage device 430, peripheral device(s) 440, portable storage medium device(s) 450, input control device(s) 480, a graphics subsystem 460, and/or an output display 470. For explanatory purposes, all components in the computer 400 are shown in FIG. 4 as being coupled via the bus 405. However, the computer 400 is not so limited. Devices of the computer 400 may be coupled via one or more data transport means. For example, the processor device 410 and/or the main memory 425 may be coupled via a local microprocessor bus. The mass storage device 430, peripheral device(s) 440, portable storage medium device(s) 450, and/or graphics subsystem 460 may be coupled via one or more input/output (I/O) buses. The mass storage device 430 may be a nonvolatile storage device for storing data and/or instructions for use by the processor device 410. The mass storage device 430 may be implemented, for example, with a magnetic disk drive or an optical disk drive. In a software embodiment, the mass storage device 430 is configured for loading contents of the mass storage device 430 into the main memory 425.

The portable storage medium device 450 operates in conjunction with a nonvolatile portable storage medium, such as, for example, a compact disc read only memory (CD-ROM), to input and output data and code to and from the computer 400. In some embodiments, the software for storing an internal identifier in metadata may be stored on a portable storage medium, and may be inputted into the computer 400 via the portable storage medium device 450. The peripheral device(s) 440 may include any type of computer support device, such as, for example, an input/output (I/O) interface configured to add additional functionality to the computer 400. For example, the peripheral device(s) 440 may include a network interface card for interfacing the computer 400 with a network 420.

The input control device(s) 480 provide a portion of the user interface for a user of the computer 400. The input control device(s) 480 may include a keypad and/or a cursor control device. The keypad may be configured for inputting alphanumeric characters and/or other key information. The cursor control device may include, for example, a mouse, a trackball, a stylus, and/or cursor direction keys. In order to display textual and graphical information, the computer 400 may include the graphics subsystem 460 and the output display 470. The output display 470 may include a cathode ray tube (CRT) display and/or a liquid crystal display (LCD). The graphics subsystem 460 receives textual and graphical information, and processes the information for output to the output display 470.

Each component of the computer 400 may represent a broad category of a computer component of a general and/or special purpose computer. Components of the computer 400 are not limited to the specific implementations provided here.

Portions of the example embodiments of the invention may be conveniently implemented by using a conventional general purpose computer, a specialized digital computer and/or a microprocessor programmed according to the teachings of the present disclosure, as is apparent to those skilled in the computer art. Appropriate software coding may readily be prepared by skilled programmers based on the teachings of the present disclosure.

Some embodiments may also be implemented by the preparation of application-specific integrated circuits, field programmable gate arrays, or by interconnecting an appropriate network of conventional component circuits.

Some embodiments include a computer program product. The computer program product may be a storage medium or media having instructions stored thereon or therein which can be used to control, or cause, a computer to perform any of the procedures of the example embodiments of the invention. The storage medium may include without limitation a floppy disk, a mini disk, an optical disc, a Blu-ray Disc, a DVD, a CD-ROM, a micro-drive, a magneto-optical disk, a ROM, a RAM, an EPROM, an EEPROM, a DRAM, a VRAM, a flash memory, a flash card, a magnetic card, an optical card, nanosystems, a molecular memory integrated circuit, a RAID, remote data storage/archive/warehousing, and/or any other type of device suitable for storing instructions and/or data.

Stored on any one of the computer readable medium or media, some implementations include software for controlling both the hardware of the general and/or special computer or microprocessor, and for enabling the computer or microprocessor to interact with a human user or other mechanism utilizing the results of the example embodiments of the invention. Such software may include without limitation device drivers, operating systems, and user applications. Ultimately, such computer readable media further includes software for performing example aspects of the invention, as described above.

Included in the programming and/or software of the general and/or special purpose computer or microprocessor are software modules for implementing the procedures described above.

While various example embodiments of the invention have been described above, it should be understood that they have been presented by way of example, and not limitation. It is apparent to persons skilled in the relevant arts) that various changes in form and detail can be made therein. Thus, the invention should not be limited by any of the above described example embodiments, but should be defined only in accordance with the following claims and their equivalents.

In addition, it should be understood that the figures are presented for example purposes only. The architecture of the example embodiments presented herein is sufficiently flexible and configurable, such that it may be utilized and navigated in ways other than that shown in the accompanying figures.

Further, the purpose of the Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the example embodiments presented herein in any way. It is also to be understood that the procedures recited in the claims need not be performed in the order presented.

### Appendix A

TABLE 1
OFFER

| Element | Description |
|---|---|
| OFFER_ID | Unique identifier associated with an offer, |
| | assigned by a mobile commerce platform |
| EXT_OFFER_ID | Unique identifier associated with an offer, |
| | assigned by a merchant or merchant |
| | system associated with the offer |
| OFFER_NAME | Label or caption associated with an offer |
| TITLE | |
| SHORT_DESCRIPTION | Brief description of an offer and its terms |
| LONG_DESCRIPTION | Detailed description of an |
| | offer and its terms |
| SMALL_IMAGE_URI | Unique identifier associated |
| | with an small-size image |
| | corresponding to an offer |
| LARGE_IMAGE_URI | Unique identifier associated |
| | with a large-size image |
| | corresponding to an offer |
| BARCODE_ID | Identifier associated with a barcode (or |
| | QR code) corresponding to an offer |
| UPCCODE | Type of barcode |
| TERMS_AND_CONDITIONS | Terms and conditions associated |
| | with an offer |
| IS_REDEEMABLE | Indicator of whether an offer is in |
| | a state in which it can be used/ |
| | redeemed in a transaction |
| STATUS | State of an offer (e.g., ready for review, |
| | live, expired) |
| USER_ID | Unique identifier associated with a user |
| | of a mobile device |
| CREATE_TSTMP | Date and time a record is created |
| UPDATE_TSTMP | Date and time a record is created |

TABLE 2
OFFER PROGRAM

| Element | Description |
|---|---|
| OFFER_PROGRAM_ID | Unique identifier associated |
| | with an offer program |
| | used to distribute an offer |
| EXT_OFFER_PROGRAM_ID | Unique identifier linking an |
| | offer program to OFFER _ |
| | PROGRAM_OFFER_ASSC |
| NAME | Name assigned to an offer program |
| PROGRAM_START_TSTMP | Start date and time for an offer |
| | program |
| PROGRAM_END_TSTMP | End date and time for an offer |
| | program |
| OFFER_PROGRAM_TYPE_ID | Unique identifier linking |
| | an offer program to |
| | OFFER_PROGRAM_TYPE |
| PARTNER_ID | Unique identifier linking an offer |
| | program to PARTNER_ID |
| DISTRIBUTION_CRITERIA_ID | Unique identifier linking an |
| | offer program to |
| | DISTRIBUTION_CRITERIA |
| PROGRAM_CHANNEL_TYPE_ID | Unique identifier used to identify a set |
| | of offer program channel type data |
| USER_ID | Unique identifier associated with a |
| | user of a mobile device |
| CREATE_TSTMP | Date and time this record is created |
| UPDATE_TSTMP | Date and time this record is updated |

TABLE 3
OFFER_PROGRAM_OFFER_ASSC

| Element | Description |
|---|---|
| OFFER_PROGRAM_OFFER_ | Unique identifier used to |
| ASSC_ID | identify a set of data |
| OFFER_PROGRAM_ID | Unique identifier of an |
| | associated offer program |
| OFFER_ID | Unique identifier of offer |
| MAX_CLIP_COUNT | Number of times an offer can be clipped |
| USER_ID | Unique identifier of user that clip an offer |
| CREATE_TSTMP | Date and time a record is created |
| UPDATE_TSTMP | Date and time a record is updated |

TABLE 5
PROGRAM_CHANNEL_TYPE

| Element | Description |
|---|---|
| PROGRAM_CHANNEL_TYPE_ID | Unique identifier used to identify |
| | a set of channel data |
| DESCRIPTION | Description of channel |

TABLE 4
OFFER_PROGRAM_TYPE

| Element | Description |
|---|---|
| OFFER_PROGRAM_TYPE_ID | Unique identifier used corresponding |
| | to a set of program data |
| DESCRIPTION | Description of a program |

TABLE 6
DISTRIBUTION_CRITERIA

| Element | Description |
|---|---|
| DISTRIBUTION_CRITERIA_ID | Unique identifier used to identify a |
| | set of distribution criteria |
| DISTRIBUTION_CRITERIA | Details of a distribution criteria |
| DISTRIBUTION_CRITERIA_ | Unique identifier linking a program to |
| TYPE_ID | DISTRIBUTION_CRITERIA_TYPE |

TABLE 7
DISTRIBUTION _CRITERIA_TYPE

| Element | Description |
|---|---|
| DISTRIBUTION_CRITERIA_TYPE_ID | Unique identifier used to |
| | identify a set of distribution |
| | criteria type data |

What is claimed is:

1. A system for managing offers in a mobile commerce environment, comprising:
at least one memory; and
a processor coupled to the at least one memory, the processor being operable to:
receive a request from a client portal system, the request including offer data and authentication data;
validate the authentication data;
generate a validation result based the validation of the authentication data;
transmit, to the client portal system, a response including the validation result; and
transmit an offer including the offer data to a mobile device, the mobile device including a mobile wallet associated with the authentication data and the offer data including an offer identifier (ID).

2. The system of claim 1, wherein the processor is further operable to:
receive one or more offers from a merchant system;
determine whether each of the one or more offers includes a required minimum set of data;
certify the one or more offers;
modify the one or more offers; and
transmit the one or more offers to the merchant system,
wherein the offer data of the clip request corresponds to the one or more offers.

3. The system of claim 1, wherein the system is placed in a validated state for a predetermined amount of time based on the validation result.

4. The system of claim 2, wherein the processor is further operable to modify the one or more offers by appending a script to the one or more offers.

5. The system of claim 2, wherein the required minimum set of data includes at least one of a (1) merchant ID, (2) expiration date, (3) offer content and (4) a number of maximum uses.

6. The system of claim 2, wherein the processor is further operable to certify the one or more offers by assigning an offer ID to each of the one or more offers.

7. The system of claim 4, wherein the script includes instructions for requesting authentication data.

8. A method for managing offers in a mobile commerce environment, comprising steps of:
receiving a request from a client portal system, the request including offer data and authentication data;
validating the authentication data;
generating a validation result based on the validating the authentication data;
transmitting, to the client portal system, a response including the validation result; and
transmitting an offer including the offer data to a mobile device, the mobile device including a mobile wallet associated with the authentication data and the offer data including an offer identifier (ID).

9. The method of claim 8, further comprising steps of:
receiving one or more offers from a merchant system;
determining whether each of the one or more offers includes a required minimum set of data;
certifying the one or more offers;
modifying the one or more offers; and
transmitting the one or more offers to the merchant system,
wherein the offer data of the clip request corresponds to the one or more offers.

10. The method of claim 8, wherein the system is placed in a validated state for a predetermined amount of time based on the validation result.

11. The method of claim 9, wherein the modifying the one or more offers includes appending a script to the one or more offers.

12. The method of claim 9, wherein the required minimum set of data includes at least one of a (1) merchant ID, (2) expiration date, (3) offer content and (4) a number of maximum uses.

13. The method of claim 9, wherein the certifying includes assigning an offer ID to each of the one or more offers.

14. The method of claim 11, wherein the script includes instructions for requesting authentication data.

15. A non-transitory computer readable-medium having stored thereon sequences of instructions for causing one or more processors to:
receive a request from a client portal system, the request including offer data and authentication data;
validating the authentication data;
transmit, to the client portal system, a response including the validation result;
transmit an offer including the offer data to a mobile device, the mobile device including a mobile wallet associated with the authentication data; and
the offer data including an offer identifier (ID).

16. The computer-readable medium of claim 15, wherein the processor is further operable to:
receive one or more offers from a merchant system;
determine whether each of the one or more offers includes a required minimum set of data;
certify the one or more offers;
modify the one or more offers; and
transmit the one or more offers to the merchant system,
wherein the offer data of the clip request corresponds to the one or more offers.

17. The computer-readable medium of claim 15, wherein the system is placed in a validated state for a predetermined amount of time based on the validation result.

18. The computer-readable medium of claim 16, wherein the sequences of instructions further cause the one or more processors to modify the one or more offers by appending a script to the one or more offers.

19. The computer-readable medium of claim 16, wherein the required minimum set of data includes at least one of a (1) merchant ID, (2) expiration date, (3) offer content and (4) a number of maximum uses.

20. The computer-readable medium of claim 16, wherein the sequences of instructions further cause the one or more processors to certify the one or more offers by assigning an offer ID to each of the one or more offers.

21. The computer-readable medium of claim 19, wherein the script includes instructions for requesting authentication data.
